(19) United States
(12) Patent Application Publication
(10) Pub. No.: US 2024/0182202 A1
(43) Pub. Date: Jun. 6, 2024

(54) Foldable Lens Box Blank And Ophthalmic Lens Box Formed Therefrom

(71) Applicant: HOYA Optical Labs of America, Inc., Lewisville, TX (US)

(72) Inventors: Ilsu Kim, Seoul (KR); Chulkyu Kim, Seoul (KR); Seungmook Lim, Seoul (KR); Daehyun Lim, Seoul (KR)

(73) Assignee: HOYA Optical Labs of America, Inc., Lewisville, TX (US)

(21) Appl. No.: 18/556,624

(22) PCT Filed: Apr. 19, 2022
(86) PCT No.: PCT/US2022/071805

§ 371 Date: Oct. 20, 2023

Related U.S. Application Data
(60) Provisional application No. 63/177,272, filed on Apr. 20, 2021.

(51) Int. Cl. B65D 5/20; B31B 50/26; B31B 120/30; B65D 5/50; B65D 85/38

(52) U.S. Cl. CPC B65D 5/2009; B31B 50/262; B65D 5/2057; B65D 5/5021; B65D 85/38; B31B 2120/302

(57) ABSTRACT

A foldable lens box blank which may be used to form an ophthalmic lens box. The ophthalmic lens box includes a pair of lens holders each being configured to hold and store an ophthalmic lens. Each of the lens holders includes a lens support opening in which a lens may be secured, with an outer edge of each lens engaging with an inner edge of each lens support opening.

### RELATED APPLICATIONS

This application claims priority to U.S. Provisional Application Ser. No. 63/177,272 filed Apr. 20, 2021 entitled Foldable Lens Box Blank and Ophthalmic Lens Box Formed Therefrom, which is hereby incorporated herein by reference in its entirety.

### FIELD OF THE INVENTION

The present invention relates generally to enclosing disc-shaped objects in a box for safe storage. More specifically, the invention relates to both a lens box blank and a lens box erected from the lens box blank, the lens box being suitable for enclosing an optical lens blank, particularly an ophthalmic lens blank, with the lens blank being secured by the box structure to prevent both horizontal and vertical movement of the lens blank in the box during transportation, and to prevent trauma to the lens blank during light impact.

### BACKGROUND OF THE INVENTION

Lens blanks are used as the starting material for corrective lenses in eyeglasses. These “generic” lens blanks are manufactured in bulk quantity by lens manufacturers with or without any particular refractive correction. The lenses basically have a convex top, concave bottom and cylindrical side wall. The side wall is eventually cut or ground to the proper fit within an ophthalmic lens frame. The correction is prepared by molding into the lens blank or by a combination of lens elements to form the appropriate prescription from a prescribing optician. Thus, the lens manufacturer is able to form or manufacture generic lens blanks in large production quantities. When a patient is treated, and corrective lenses are prescribed by an optometrist or other professional, an optician may be employed to select the proper lens or combine the proper lens blanks. To prevent an optician from having to maintain a very large supply of lenses all tailored to different prescriptions, lens blanks may be utilized. In that case, an optician would then select a generic lens blank and grind it to the required correction or frame fit. With the large number of lenses being prescribed, there is a large number of lens blanks being shipped from the manufactures to optical shops across the country.

The “generic” lens blanks have a convex top surface, a concave bottom and a generally cylindrical side wall. The lens blanks are usually designed and manufactured so that the convex top may remain intact, the grinding occurring only on the bottom surface (and sides for frame fit). Thus, it is important that the convex top surface remain free of any scratches or other imperfections as it will not be subsequently abraded or smoothed. Therefore, an important consideration in designing an enclosure box for transportation of such lens blanks is that contact between the convex top surface of the lens blank and the shipping container must be minimized during shipment. The shipping container should also be sufficiently sturdy that if accidental impact occurs during transportation, the box will absorb the impact without exposing the ophthalmic lens blank to contact with an abrading surface. The lens blank must be retained within the shipping enclosure such that vertical movement of the lens blank within the enclosure is minimized. One additional benefit of restricting movement on the lens blank is elimination of the annoying “rattling” that accompanies random movement of an unsecured object within a box.

Numerous examples exist of containers adapted to transport lenses and the like. One example of such prior art is Seger, U.S. Pat. No. 3,122,298, which discloses a container having slightly inclined sidewalls, handles, and a removable top. In the Seger enclosure, the inclination of the side walls is outwardly from the base upward. Thus, the Seger enclosure would not be operative to prevent vertical movement of the lens blank.

Another prior art example of a container is Buttery, U.S. Pat. No. 2,372,312, which discloses a folding octagon paper box having a general folding pattern and configuration for assembly of an octagonal container. Buttery does not have inclined sidewalls and thus would not be adapted to restrict vertical movement of the lens blank.

Towell, U.S. Pat. Nos. 1,968,660 and 1,968,661, show open topped display containers for candy and other confectionery having outwardly inclined side walls and no top to enclose the container.

Yet other prior art includes the use of styrofoam half sections to enclose lens blanks which are then manually inserted into a box enclosure for shipment.

U.S. Pat. No. 5,454,469 describes a lens box for safe storage and transportation of an optical lens blank having convex top and concave bottom surfaces and a cylindrical side wall, the junction of said top and bottom surfaces with said side wall defining a top ridge and a bottom ridge, comprising: vertically spaced apart, substantially parallel top panel and bottom panel; horizontally spaced apart, substantially parallel first and second side walls, said side walls being generally perpendicularly connected to said top and bottom panels; a plurality of gussets, each of said gussets being connected to said top and bottom panels thereby defining an interior generally enclosed space between said top and bottom panels, said side walls and said gussets, each gusset and said top panel further defining an interior angle and an exterior angle, and each gusset and said bottom panel further defining an interior angle and an exterior angle and wherein said interior angle between each gusset and said top panel is greater than said interior angle between that same gusset and said bottom panel such that said gussets are inclined upwardly and inwardly from said bottom panel such that upon insertion of a said lens blank into said lens box, said gussets tangentially contact said lens blank top ridge at a point corresponding to the intersection of said lens blank side wall and said gussets thereby securing said lens blank against any substantial horizontal and vertical movement in said box.

### SUMMARY OF THE INVENTION

The invention encompasses both a T-square lens box blank that can be folded and secured to form a lens box and the lens box formed from the lens box blank. The cross-bar of the T-square lens box blank has slidable/adjustable lens supporting frames on both sides of the cross-bar. The rear stem of the T-square lens box blank provides the top of the lens box structure and both the front and rear of the lens box. The resultant lens box places little contact surface area of the internal box support against the front lens surface, with the majority of the lens support being provided by contact of the lens box with the edges of the lens, not the viewing surface of the lens.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIG. 1 shows a completely opened T-square lens box blank that can be folded and secured into a lens box.

FIG. 2A shows a prospective view of a partially folded T-square lens box blank that is in a process of being folded into a lens box.

FIG. 2B shows a perspective view of a partially folded T-square lens box blank that is in a process of being folded into a lens box.

FIG. 2C shows a prospective view of a partially folded T-square lens box blank that is in a process of being folded into a lens box.

FIG. 2D shows a prospective view of a T-square lens box blank that has been folded to form a lens box.

FIG. 3 shows a perspective view of a cut-out of half a lens box according to the invention.

FIG. 4 shows a completely opened ‘winged’ T-square lens box blank that can be folded and secured into a lens box with an additional locking mechanism provided.

FIG. 5 shows a perspective view of partially folded ‘winged’ T-square lens box blank according to one embodiment of the present invention.

FIG. 6 shows a perspective view of partially folded ‘winged’ T-square lens box blank according to one embodiment of the present invention.

FIG. 7 shows a perspective view of partially folded ‘winged’ T-square lens box blank according to one embodiment of the present invention.

FIG. 8 shows a perspective view of partially folded ‘winged’ T-square lens box blank according to one embodiment of the present invention.

### DETAILED DESCRIPTION

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

A lens box according to the present invention has many advantages over other available lens boxes. The lens box of the invention can, for example:
a) provide a lens box blank that can be easily cut or converted to fit different size lenses, without having to alter the overall size of the lens box frame;
b) can be used on a wide variety of semi-finished lenses with different surface treatments, without modification of the box structure;
c) the box structure will minimize the potential for scratching within the box, both during transportation and insertion of the lens into the box;
d) the box is capable of firmly supporting lenses within the box with minimum potential for contact between the front of the lens and surfaces of the box;
e) the box structure eliminates the use of supplemental lens supports within the box, such as plastic cups, foam sheets, or packing material, and eases recycling problems or environmental issues since a paper-based composition for the box allows for a single composition recycling requirement, and paper is the most easily recycled material;
f) is very inexpensive as compared to existing commercially viable lens box systems;
g) lends itself to automated packaging techniques because of the simple folding and securing steps that are used in construction from the T-square;
h) lends itself to direct recycling/reuse, rather than merely recycling;
i) is readily openable and closable without destruction or diminution of the box integrity or appearance; and
j) provides a very secure reduced dust environment, both because of its relatively tight closure and complete surrounding of the lens, and because of plastic enclosure elements that can generate triboelectric charges.

The invention includes both a lens box blank and a lens box. The lens box blank for folding into a lens box may, for example, comprise: a cross-bar comprising aligned box segments and a stem comprising aligned box segments; the stem box segments including at least a front panel, a top panel, a bottom panel, and a rear panel separated by folding lines between panels; the cross-bar box segments comprising in symmetry about the bottom panel at least two side panels, at least two lens support frame top panels, at least two lens support frame side panels, each lens support side panel with an opening to nestle a lens, and at least two lens support frame securing flaps. The lens box blank may have at least one of the rear panel and the bottom panel provided with a securing flap thereon. The lens box blank may also have the lens support frame side panel openings as at least partially arcuate. Also, the top panel and the at least one lens support frame top panel may have a tab engaging system to connect the top panel and the at least one lens support frame top panel.

The lens box for holding an ophthalmic lens may comprise: a cross-bar comprising aligned box segments and a stem comprising aligned box segments; the stem box segments including at least a front panel, a top panel, a bottom panel, and a rear panel separated by folding lines between panels; the cross-bar alignment of box elements comprising, in symmetry about the bottom panel, at least two side panels, at least two lens support frame top panels, at least two lens support frame panels with an opening in each lens support frame panel to nestle a lens, and at least two lens support frame securing flaps, the lens support frame securing flaps being secured to the bottom panel to allow three sides of a quadrilateral frame formed by the bottom panel, a side panel, a support frame top panel and a lens support frame panel to be able to shift parallel to the support frame top panel.

The box of the invention can be manufactured from traditional paper product sheeting, usually high quality paper products, light cardboard products, glossy (high quality surface coated) paper products, paper board products, clay coated paper board products, and the like. The coating weight may be selected as desired, as between 0.05 to 5 kg/m2 or 0.1 and 3 kg/m2 sheet. A better understanding of the blank and the box can be appreciated by consideration of the figures.

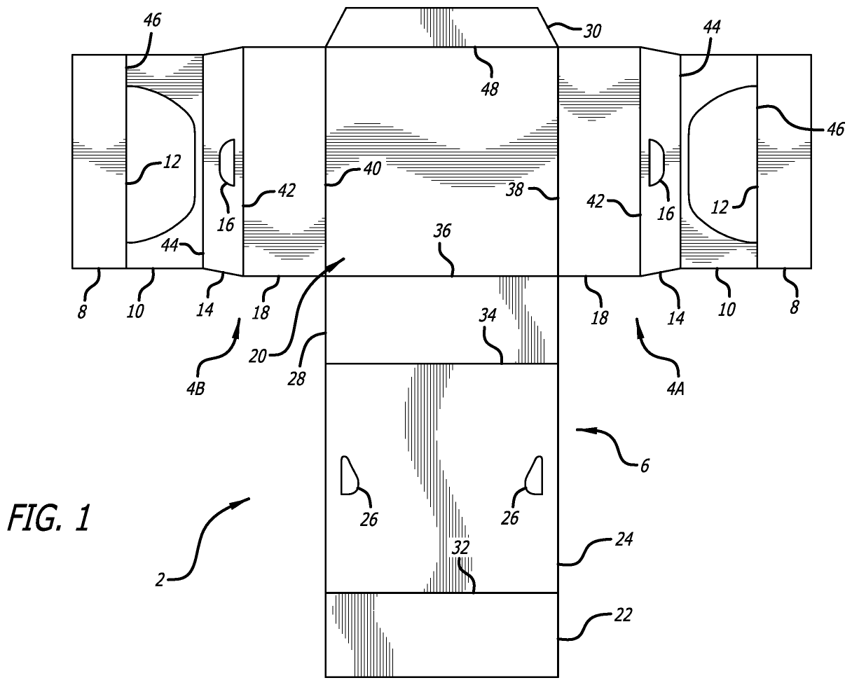

FIG. 1 shows a T-square lens box blank 2 that may comprise cross-bar segments 4A and 4B and a vertical stem segment 6. The cross-bar segments 4A and 4B tend to be approximately symmetrical with two lens securing panels 8, two lens support frame panels 10 (with lens support openings 12 therein), two lens support frame top panels 14 (with optionally preferred closure or locking elements 16), and lens box side panels 18. The intersection of the cross-bar segments 4A and 4B and the vertical stem segment 6 includes the bottom of the box segment 20. The vertical stem segment 6 may comprise a top of the box securing flap 22, the top panel 24 (with two optionally preferred closure engagement elements 26), front panel 28, the bottom of the box base segment 20, and preferably a securing flap 30 in one example embodiment. All straight, solid lines (e.g., 32, 34, 36, 38, 40, 42, 44, 46, and 48) may be foldable lines, serrations, embossments or the like.

With reference to FIG. 1, it can be seen that in another example embodiment a lens box blank 2 may comprise a base segment 20, a stem segment 6 extending from a bottom side of the base segment 20, a first cross-bar segment 4A extending from a first side of the base segment 20, and a second cross-bar segment 4B extending from a second side of the base segment 20. The stem segment 6 may comprise a first securing flap 22, a top panel 24, and a front panel 28. The top panel 24 will generally form the top of the lens box 400, the front panel 28 will generally form the front of the lens box 400, and the first securing flap 22 will generally form the rear of the lens box 400 (either by itself, or in conjunction with a second securing flap 30 as discussed herein).

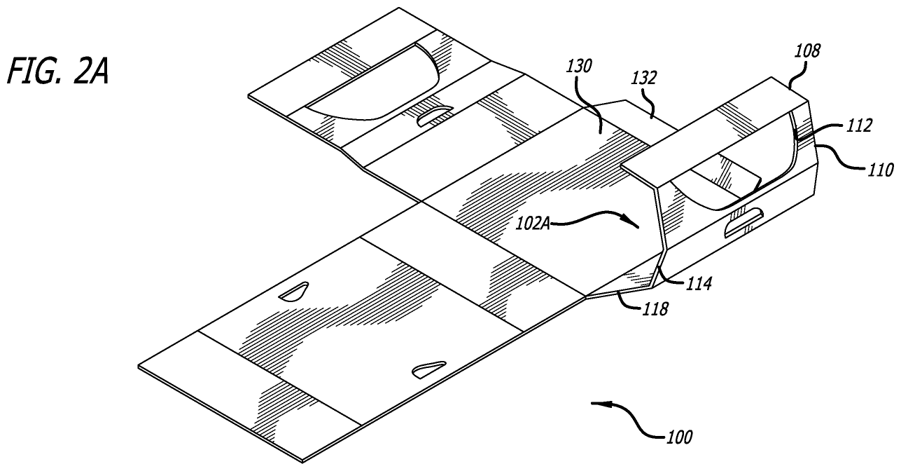

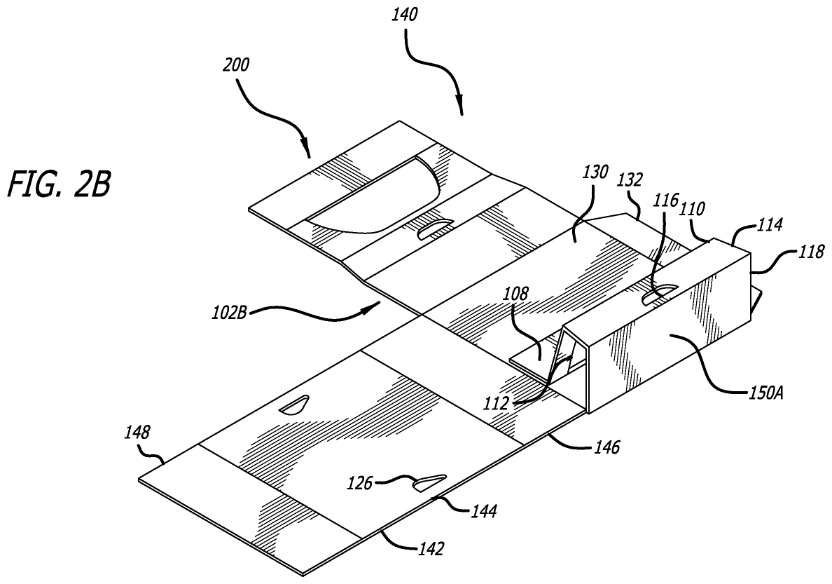

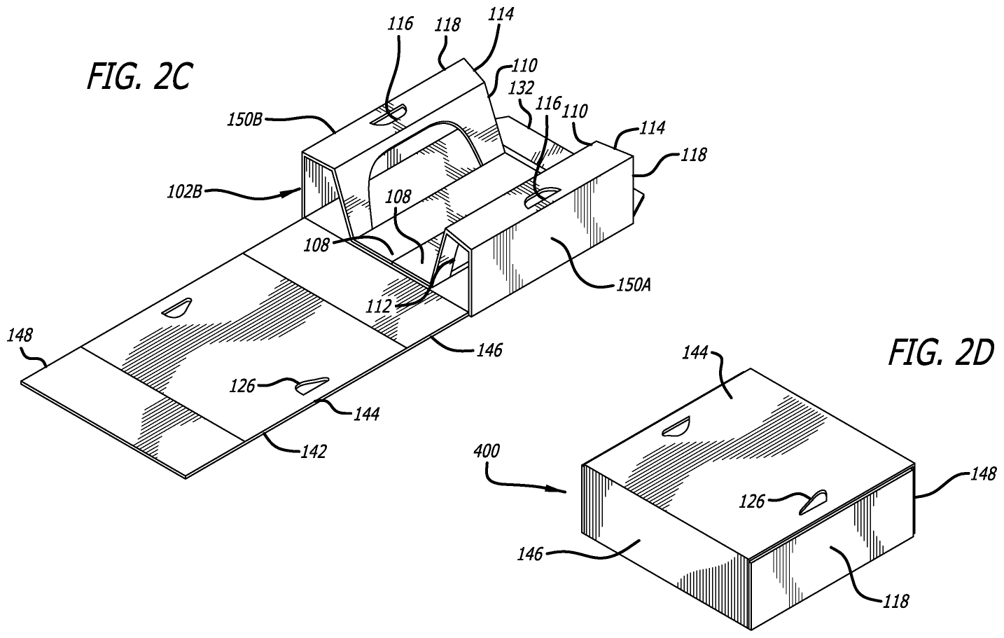

Continuing to reference FIG. 1, it can be seen that the first cross-bar segment 4A may comprise a first lens securing panel 8, a first lens support frame panel 10, a first lens support frame top panel 14, and a first lens side panel 18. Each of the foregoing features of the first cross-bar segment 4A may be folded to form a generally rectangular first lens holder 150A configured to hold and store a first ophthalmic lens (FIG. 2B). Similarly, the second cross-bar segment 4B may comprise a second lens securing panel 8, a second lens support frame panel 10, a second lens support frame top panel 14, and a second lens side panel 18. Each of the foregoing features of the second cross-bar segment 4B may be folded to form a generally trapezoidal second lens holder 150B configured to hold and store a second ophthalmic lens (FIG. 2C). When constructed to form a lens box 400 as shown in FIG. 2D, the first lens holder 150A may be positioned adjacent to a first side of the lens box 400 and the second lens holder 150B may be positioned adjacent to a second side of the lens box 400.

The first lens support frame panel 10 may include a first lens support opening 12 and the second lens support frame panel may include a second lens support opening 12. Each of the respective lens support openings may be utilized to insert and/or remove a lens to and/or from a respective lens holder 150A or 150B. By positioning each lens within its own contained lens holder, the lenses may be separated from each other during storage/transport to prevent them from contacting each other and potentially causing damage.

The first lens support frame top panel 14 may include a first locking element 16 and the second lens support frame top panel 14 may include a second locking element 16. The top panel may include one or more closure engagement elements which may be used to close the lens box. The top side of the base segment 20 may include a second securing flap 30 which may be configured to be removably or fixedly connected to the first securing flap 22 to form the rear panel of the lens box 400.

FIG. 2A shows T-square lens box blank frame 100, with a first symmetrical side of the cross-bar segment 102A being raised to be folded into a partial lens box shape. A first lens side panel 118 has been partially elevated, also raising a first lens support frame top panel 14, a first lens support frame panel 110 (with a first lens support opening 112 therein) and a first lens securing panel 108. As can be seen in FIG. 2B, the folding and securing of the T-square lens box blank 100 continues by lowering the first lens securing panel 108 on the first symmetrical side of the cross-bar segment 102 into contact with a surface 130 of the lens box base segment 130 (20 in FIG. 1) and then securing (adhering, fusing, bonding, stapling, or otherwise associating) the first lens securing panel 108 to a surface of the lens box base segment 130.

FIG. 2B further shows a perspective view of T-square lens box blank 200 more completely folded, yet still incompletely folded. The first lens side panel 118 is shown in a relatively vertical position with regard to the lens box base segment 130, although, as explained in greater detail later, the first lens side panel 118, the first lens support frame top panel 114, and the first lens support frame panel (with first lens support opening 112 therein) shift or float or rotate to enable positioning of the first lens support opening 112 over a lens (not shown) placed within the box 400 (FIG. 2D). The first lens securing panel 108 is secured to the lens box base segment 130 to stabilize the movement of the first lens side panel 118. All three segments, the first lens side panel 118, the first lens support frame top panel 114, and the first lens support frame panel 110 (with first lens support opening 112 therein) shift to enable the first lens support frame panel 110 to engage a lens with the first lens support opening 112.

FIG. 2C illustrates that the second cross-bar segment 102B can be folded in a similar manner. The second lens side panel 118, the second lens support frame top panel 114, the second lens support frame panel 110 (with the second lens support opening 112 therein) and the second lens securing panel 108 on the second cross-bar segment 102B are raised, folded and then vertically downwardly lowered in the same manner as described in FIG. 2B such that in the final step, the second lens securing panel 108 comes into contact with the surface 130 of the lens box base segment 130. The first cross-bar segment 102A and the second cross-bar segment 102B of the lens box blank 200 are folded in a manner such that the two vertically raised lens side panels 118 on both sides 102 and 104 of the cross-bar segment 4 are positioned parallel to each other, the two horizontally folded lens support frame top panels 114 on both cross-bar segments 102A and 102B are positioned parallel to each other, and the two vertically downwardly folded lens support frame panels 110 (with lens support opening 112 therein) and the two lens securing panels 108 on both cross-bar segments 102A and 102B are positioned parallel to each other in the partially folded lens box blank 200.

As can be seen in FIG. 2D, the remainder of the unfolded stem segment 142 would also be folded in a logical sequence to complete the lens box 400. The lens box front panel 146 is folded upward, the lens box top panel 144 is folded over the top of the lens support frame top panel 114 (with the closure element 116, and the first securing flap 148 are folded downward. Then the first securing flap 148 is secured (e.g., again adhesively, fused, stapled, bonded, etc.) to the second securing flap 132. The closure elements 116 and 126 are designed to engage or lock the segments of the lens box after closure, as shown in FIG. 2D.

In one exemplary method of forming the lens box 400 from the lens box blank 100, the first cross-bar segment 4A may be folded over the base segment 30 to form the first lens holder 150A as shown in FIGS. 2A and 2B, the second cross-bar segment 4B may be folded over the base segment 30 to form the second lens holder 150B as shown in FIG. 2C, and the stem segment may be folded over the first and second lens holders 150A and 150B to form the lens box 400 as shown in FIG. 2D.

FIG. 2D illustrates an exemplary embodiment of a lens box 400 which has been fully folded and formed. As shown, the lens box 400 may comprise a base panel (shown as 130 in FIG. 2B) which forms the bottom of the lens box 400, a top panel 144 which forms the top of the lens box 400, a pair of side panels 118 extending between the base panel and the top panel 144, and a front panel 146 extending between the base panel and the top panel 144. The pair of side panels 118 may include a first side panel and a second side panel. A rear panel may be formed from one or more securing flaps 148 and 132 as described herein.

The lens box 400 may include a first lens holder 150A for holding a first lens and a second lens holder 150B for holding a second lens. The first and second lens holders may be internal to the formed lens box as shown in FIG. 2D. The first lens holder 150A may be positioned adjacent to the first side panel 118 and the second lens holder 150B may be positioned adjacent to the second side panel 118. The first and second lens holders may each comprise a rectangular-shaped housing; with the first lens holder 150A forming a first cavity for receiving the first lens and the second lens holder 150B forming a second cavity for receiving the second lens. The first and second lens holders may be distally-spaced apart from each other to ensure that the pair of lenses do not come into contact with each other and cause potential damage.

The first lens holder 150A may include a first lens support opening 112 through which the first lens may be inserted and/or removed into or from the first cavity. Similarly, the second lens holder 150B may include a second lens support opening 112 through which the second lens may be inserted and/or removed into or from the second cavity. Each of the lens support openings 112 may also function to hold the lens in place, with the outer edges of the lenses engaging with the inner edges of the respective lens support openings such that no surface of the lenses, other than their respective outer edges, are in contact with the lens box as described below.

The lens box 400 may include a first securing flap 148 pivotably connected to the top panel 144 and a second securing flap 132 pivotably connected to the bottom panel (130 in FIG. 2B); the first and second securing flaps 148, 132 coming together to form the rear panel of the lens box 400.

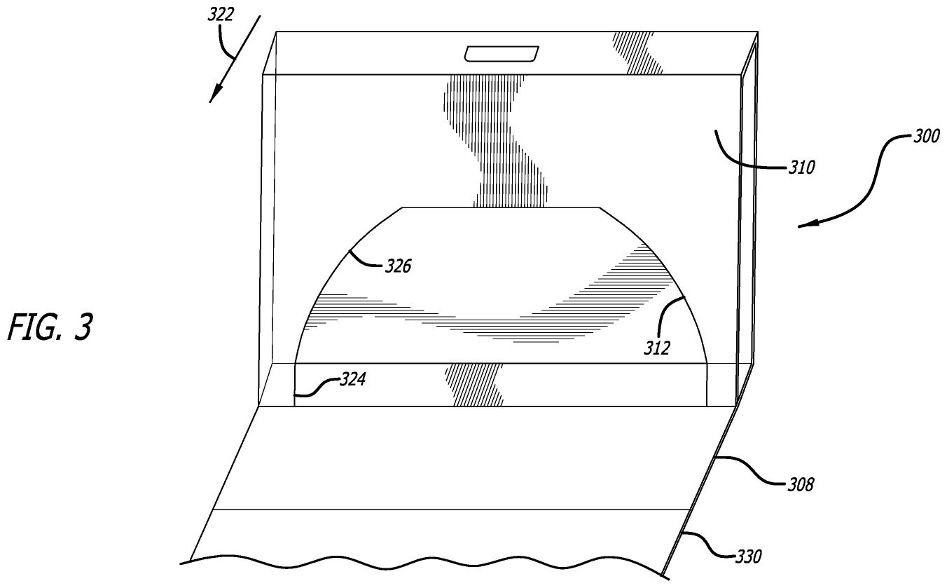

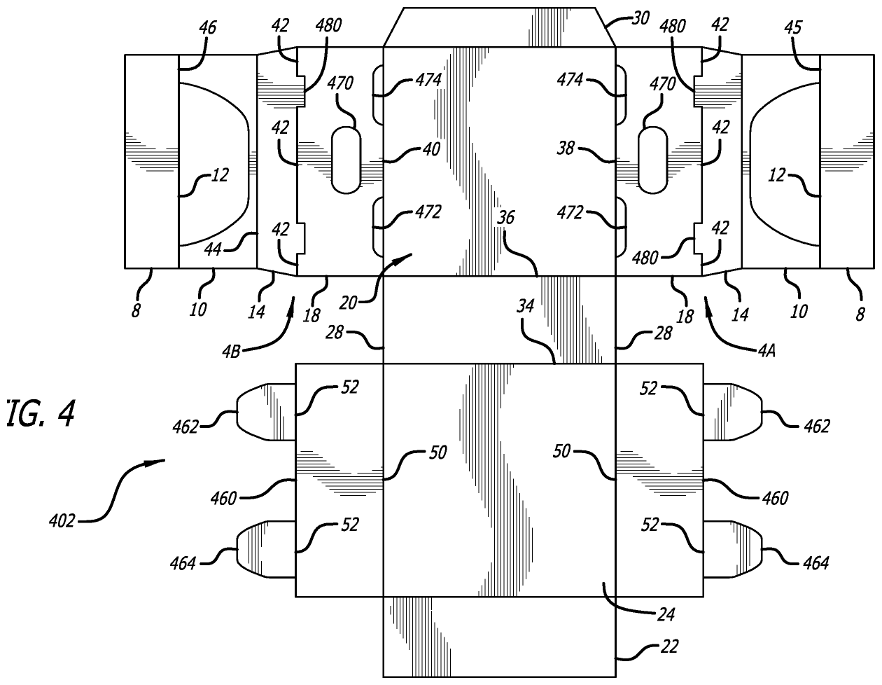

The lens support openings 112 are used to secure a lens (not shown) within the lens box 400. As mentioned above, the shifting of the three segments, 1) the lens side panels 118, 2) the lens support frame top panels 114, and 3) the lens support frame panels 110 (with lens support openings 112 therein) moves the lens support openings 112 over the lens. The securement of the lens within the lens support openings 112 can be easily explained by reference to FIG. 3.

FIG. 3 shows a perspective cut-away view of half of the inside of a lens box according to the invention 300. The lens support frame panel 310 (with lens support opening 312 therein) will receive a lens in opening 312. The lens support frame securing panel 308 is secured to the lens box bottom segment 330. This stabilizes the shifting of the three segments, the lens side panels 118, 2) the lens support frame top panels 114, and 3) the lens support frame panels 110 (with lens support openings 112 therein) so that as they are shifted along direction 322, the lens support opening 112 engages a lens. The lens (not shown) will have its edges engage frictionally or even somewhat compressively by the sides 324 of the lens support opening 112 against the edges of the lens. The curved inside edge 326 of the lens support opening 112 will restrain against upward movement of the lens within the lens support opening 112. In this manner, the lens box of the invention tends to limit contact of the ophthalmic surfaces of the lens with any surfaces that would scratch or damage the lens, except for areas immediately around the edges of the lens, which are ordinarily cut or polished off the lens for fitting into frames.

Other configurations accomplishing ancillary similar results are well within the skill of the artisan. For example, rather than having first securing flap 22 secured to second securing flap 30, as shown in FIG. 1, there could be an additional securing flap extension on flap 22 or flap 30 that would extend over the bottom segment of the box 20 or extend over the top of the box 24, respectively to effect a similar securing function. Soft lining material may be placed along the edges of the lens support opening 12 or over the lens (e.g., a cheesecloth) to further reduce the possibility of scratching without creating any significant disposal or recycling issue. As illustrated in FIG. 1, the slope along the side of the lens support frame top panel 14 is done for convenience, and is not essential. The areas of segments 24 and 20, and segments 22 and 28, and segments 18 are approximately equal when symmetry in the box is desired. The terms vertical stem and cross-bar, when used with respect to the alignment or position of segments is a relative term, and it is not essential that one or the other must be specifically positioned in a vertical alignment for use of the blank or the box. The two series of segments tend to be perpendicularly oriented with respect to each other, with the cross-bar series of segments being perpendicular to the vertical stem series of segments, and at least one segment contained within both the cross-bar series and the vertical stem series (the bottom of the box is usually shown in this manner in the descriptions of this invention.

FIG. 4 shows a ‘winged’ T-square lens box blank 402 that may be comprised of a cross-bar 4 and a stem 6 comprising aligned box segments. The cross-bar segment 4 tends to be approximately symmetrical with two lens support frame securing panel 8, two lens support frame side panels 10 (each with at least one lens support opening 12 therein), two lens support frame top panel 14 (shown without closure or locking elements that were shown in FIG. 1, but which may include such elements if desired), and two lens side panels 18. The intersection of the cross-bar 4 and the vertical stem segment 6 may include the bottom segment 20 (i.e., the bottom of the box panel).

The stem 6 comprises a lens box top panel 24 (shown without optional closure elements that are shown in FIG. 1), a lens box front panel 28, the lens box bottom panel 20, top of the box securing flap 22, the bottom of the box panel 20, and preferably a securing flap 30. All straight, solid lines (e.g., 32, 34, 36, 38, 40, 42, 44, 46, 48 50 and 52) are foldable lines, serrations, embossments or the like. In this ‘winged’ T-square lens box frame 402 there are additional features as compared to the earlier described T-square lens box frame of FIG. 1. Overlap side flaps or segments 460 are provided, with these overlap side flaps or segments 460 being provided with a set of tabs 462 and 464 to assist in securing or locking the finally constructed lens box. The lens side box panel 18 is provided with additional elements and features that also distinguish it from the T-square lens box frame of FIG. 1. Two receiving slots 472 and 474 are provided to receive the tabs 462 and 464, respectively. Additionally, an opening or hole 470 is provided to assist the user in opening the completed lens box, for viewing the lens within the box, for providing air flow within the box, and for enabling the user to readjust the position of the lens within the lens box.

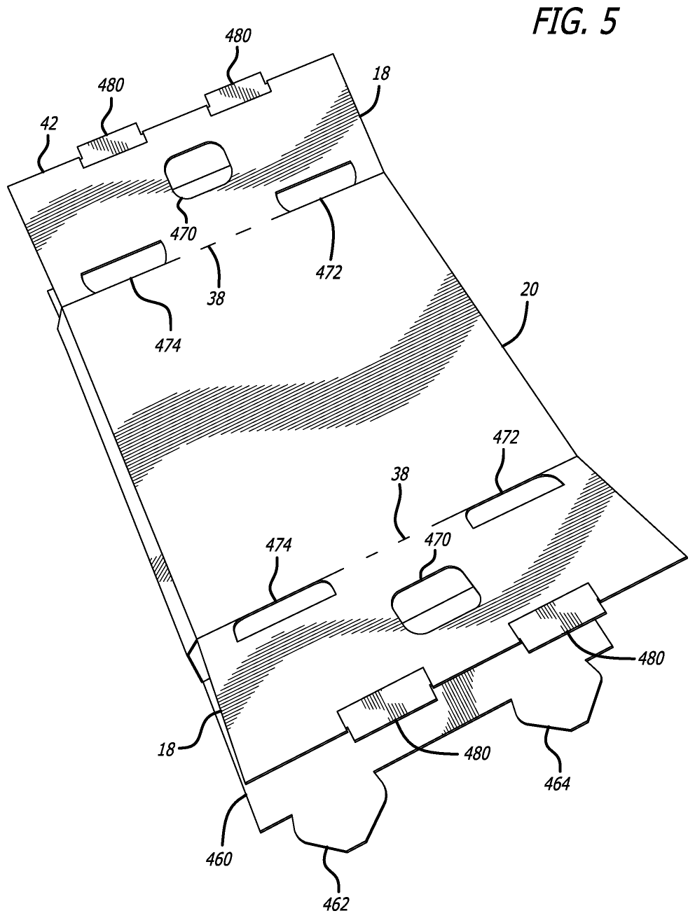

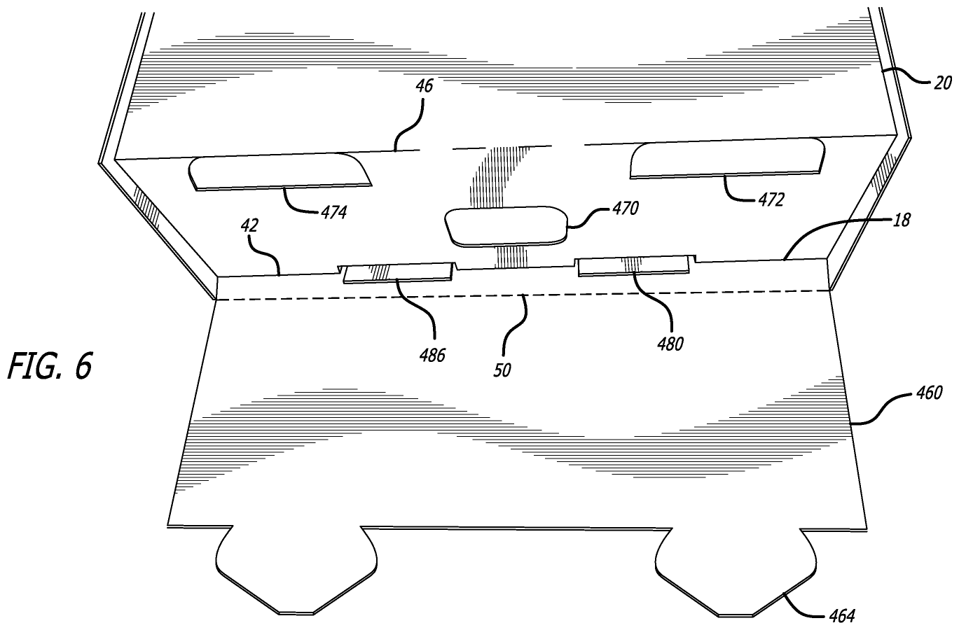

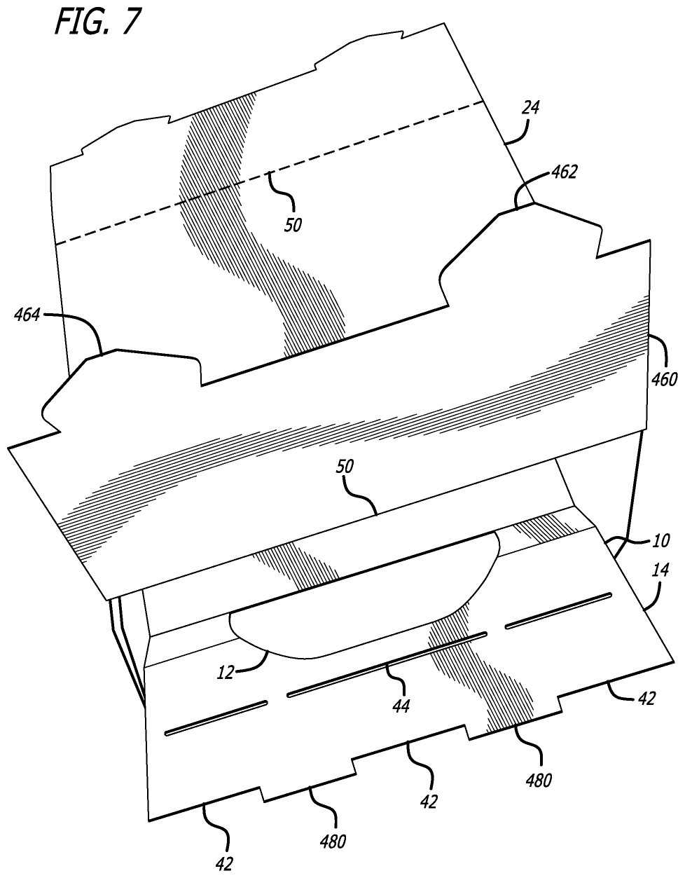

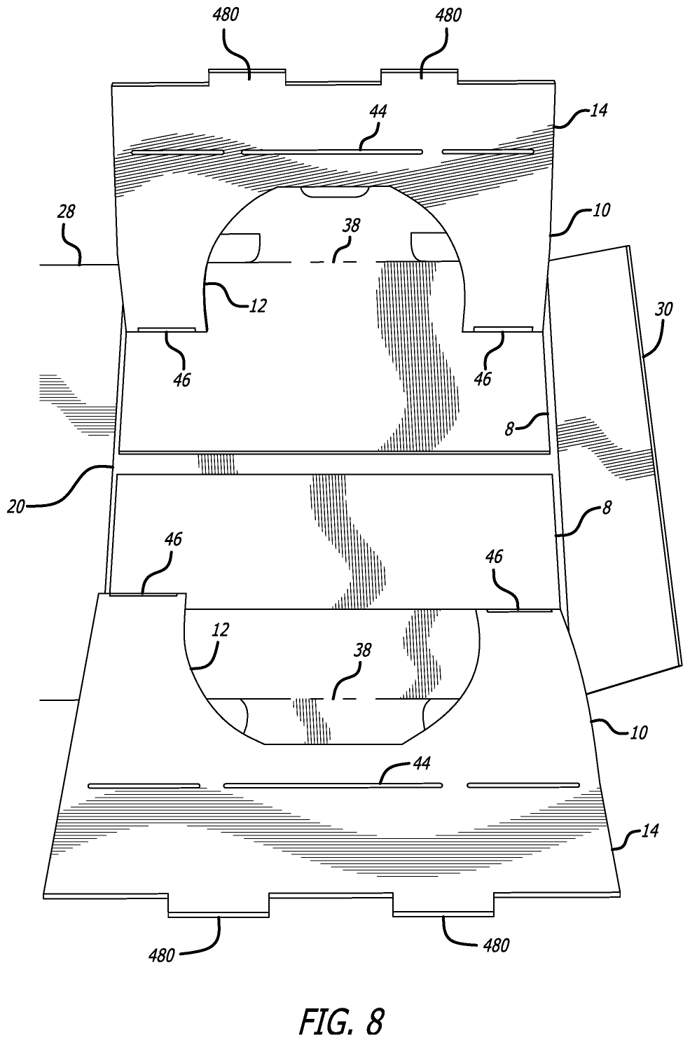

In certain embodiments, the cross-bar segment 4 of the lens box frame 402 employs side panel tabs 480. The side panel tabs 480 are formed along foldable line 42 defining the intersection of the lens side panel 18 and the lens support frame top panel 14. The side panel tabs 480 are formed by interruptions in foldable line 42 where “U” shaped cuts are made into the lens side panels 18. As shown in FIGS. 5-8, when the lens side panel 18 and the lens support frame top panel 14 are folded relative to one another along foldable line 42, i.e. when the lens box frame 402 is assembled or partially assembled into a lens box 400, the side panel tabs 480 form protrusions or spacers that extend outward from the interior of the lens box frame 402. Hence, when the overlap side flaps or segments 460 are folded over the side box panel 18, the side panel tabs 480 are pushed inward by the overlap side flaps or segments 460 which, in turn, pushes the lens support frame top panel 14 and the connected lens support frame side panels 10 further interior of the assembled lens box frame 402. Accordingly, the side panel tabs 480 provide for a tighter, more secure fit of the assembled lens box 400 around a lens.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1. A lens box blank for folding into a lens box comprises:
a base segment;
a stem segment extending from a bottom side of the base segment, the stem segment comprising a first securing flap, a top panel, and a front panel;
a first cross-bar segment extending from a first side of the base segment, the first cross-bar segment comprising a first lens securing panel, a first lens support frame panel, a first support frame top panel, and a first side panel, wherein an intersection of the first support frame top panel and the first side panel comprises first side panel tabs; and
a second cross-bar segment extending from a second side of the base segment, the second cross-bar segment comprising a second lens securing panel, a second lens support frame panel, a second support frame top panel, and a second side panel, wherein an intersection of the second support frame top panel and the second side panel comprises second side panel tabs; and,
wherein the base segment, the stem segment, the first cross-bar segment, and the second cross-bar segment are configured to be folded to form a lens box.

2. The lens box blank for folding into a lens box of claim 1, wherein the first cross-bar segment is configured to be folded to form a first lens holder of the lens box.

3. The lens box blank for folding into a lens box of claim 1, wherein the second cross-bar segment is configured to be folded to form a second lens holder of the lens box.

4. The lens box blank for folding into a lens box of claim 1, wherein the first lens support frame panel includes a first lens support opening including a first inner edge configured to engage with a first outer edge of a first lens.

5. The lens box blank for folding into a lens box of claim 4, wherein the second lens support frame panel includes a second lens support opening including a second inner edge configured to engage with a second outer edge of a second lens.

6. The lens box blank for folding into a lens box of claim 1, wherein the first support frame top panel includes a first locking element.

7. The lens box blank for folding into a lens box of claim 6, wherein the second support frame top panel includes a second locking element.

8. The lens box blank for folding into a lens box of claim 1, wherein the top panel includes a closure engagement element.

9. The lens box blank for folding into a lens box of claim 1, further comprising a second securing flap extending from a top side of the base segment.

10. A method of constructing a lens box from the lens box blank of claim 1, comprising the steps of:
folding the first cross bar segment over the base segment to form a first lens holder;
folding the second cross bar segment over the base segment to form a second lens holder; and
folding the stem segment over the first lens holder and the second lens holder to form the lens box.

11. A lens box for storing ophthalmic lenses, comprising:
a base panel;
a top panel;
a pair of side panels extending between the base panel and the top panel, the pair of side panels including a first side panel comprising first side panel tabs and a second side panel comprising second side panel tabs;
a front panel extending between the base panel and the top panel;
a first lens holder for holding a first lens, the first lens holder extending from the first side panel to form a first cavity for receiving the first lens; and
a second lens holder for holding a second lens, the second lens holder extending from the second side panel to form a second cavity for receiving the second lens;
wherein the first side panel tabs and the second side panel tabs are configured to push the first lens holder and the second lens holder further interior for a secure fit of the first lens and the second lens.

12. The lens box for storing ophthalmic lenses of claim 11, wherein the first lens holder includes a first lens support opening including a first inner edge configured to engage with a first outer edge of the first lens.

13. The lens box for storing ophthalmic lenses of claim 12, wherein the second lens holder includes a second lens support opening including a second inner edge configured to engage with a second outer edge of the second lens.

14. The lens box for storing ophthalmic lenses of claim 11, further comprising a first securing flap pivotably connected to the top panel.

15. The lens box for storing ophthalmic lenses of claim 14, further comprising a second securing flap pivotably connected to the bottom panel.

16. The lens box for storing ophthalmic lenses of claim 11, wherein the first lens holder includes a first locking element.

17. The lens box for storing ophthalmic lenses of claim 16, wherein the second lens holder includes a second locking element.

18. The lens box for storing ophthalmic lenses of claim 17, wherein the top panel includes a closure engagement element.

19. The lens box for storing ophthalmic lenses of claim 11, further comprising a pair of side flaps pivotably connected to the top panel, the pair of side flaps including a first side flap and a second side flap, wherein the first side flap includes a first tab, and wherein the second side flap includes a second tab.

20. A method of storing lenses in a lens box, the lens box comprising a first lens holder having a first lens support opening and first side panel tabs extending outward and a second lens holder having a second lens support opening and second side panel tabs extending outward, comprising the steps of:
inserting a first lens in the first lens support opening of the first lens holder of the lens box such that a first outer edge of the first lens engages with a first inner edge of the first lens support opening;
inserting a second lens in the second lens support opening of the second lens holder of the lens box such that a second outer edge of the second lens engages with a second inner edge of the second lens support opening; and
securing the first and second lenses in the first and second lens holders by pushing the first and second side panel tabs inward such that the first and second lens holders are being pushed further interior for a tighter fit of the first and second lenses.
